(19) United States
(12) Patent Application Publication
(10) Pub. No.: US 2025/0192365 A1
(43) Pub. Date: Jun. 12, 2025

(54) ELASTIC SHEET FOR ALL-SOLID RECHARGEABLE BATTERY AND ALL-SOLID RECHARGEABLE BATTERY

(71) Applicant: SAMSUNG SDI CO., LTD., Yongin-si (KR)

(72) Inventors: Riyul KIM, Yongin-si (KR); Isaac SHIN, Yongin-si (KR); Kwang Jong SUH, Yongin-si (KR); Young Gyoon RYU, Yongin-si (KR)

(21) Appl. No.: 18/926,413

(22) Filed: Oct. 25, 2024

(30) Foreign Application Priority Data
Dec. 6, 2023 (KR) 10-2023-0175956

(51) Int. Cl. H01M 50/446; H01M 50/42; H01M 50/431

(52) U.S. Cl. CPC H01M 50/446; H01M 50/42; H01M 50/431

(57) ABSTRACT

An elastic sheet for an all-solid rechargeable battery and an all-solid rechargeable battery that includes the elastic sheet for an all-solid rechargeable battery, the elastic sheet having a thickness of 100 μm to 500 μm, and a strain of 10% or less in a vacuum environment of 0.1 MPa.

### CROSS-REFERENCE TO RELATED APPLICATION

This application claims priority to and the benefit of Korean Patent Application No. 10-2023-0175956 filed in the Korean Intellectual Property Office on Dec. 6, 2023, the entire contents of which are incorporated herein by reference.

### BACKGROUND

### 1. Field

Embodiments relate to an elastic sheet for an all-solid rechargeable battery and an all-solid rechargeable battery including the same.

### 2. Description of the Related Art

A portable information device, e.g., a cell phone, a laptop, a smart phone, or the like or an electric vehicle may use a rechargeable lithium battery having high energy density and easy portability as a driving power source. Recently, research has been actively conducted to use a rechargeable lithium battery with high energy density as a driving power source or power storage power source for hybrid or electric vehicles.

### SUMMARY

The embodiments may be realized by providing an elastic sheet for an all-solid rechargeable battery, the elastic sheet having a thickness of 100 μm to 500 μm, and a strain of 10% or less in a vacuum environment of 0.1 MPa.

The thickness of the elastic sheet may be 300 μm.

The strain may include a strain of a width of the elastic sheet.

The elastic sheet may include a foam.

The elastic sheet may include a polymer resin, and the polymer resin may include a polyacrylate, a polyurethane, silicon, a fluorine polymer, a polyether polyol, a polyester polyol, a polycarbonate polyol, a copolymer thereof, or combinations thereof.

The polyacrylate may include a C1 to C20 alkyl acrylate, a hydroxy-substituted C1 to C20 alkyl acrylate, or a combination thereof.

The elastic sheet may further include hollow particles.

The hollow particles may be included in an amount of 1 part by weight to 8 parts by weight, based on 100 parts by weight of the polymer resin.

The hollow particles may include inorganic hollow particles, organic hollow particles, or a combination thereof, the inorganic hollow particles may include glass, a metal oxide, a metal carbide, a metal fluoride, or a combination thereof, and the organic hollow particles may include an acryl resin, a vinyl chloride resin, a urea resin, a phenol resin, or a combination thereof.

An average particle diameter D50 of the hollow particles may be 2 μm to 100 μm.

The elastic sheet may further include elastic particles, and the elastic particles may include alkyl acrylate, an olefin, butadiene, isoprene, styrene, acrylonitrile, a copolymer thereof, or combinations thereof.

The elastic particle may be included in an amount of 0.1 parts by weight to 5 parts by weight, based on 100 parts by weight of the polymer resin.

An average particle diameter D50 of the elastic particles may be 10 nm to 900 nm.

The elastic sheet may further include inorganic particles, and the inorganic particles may include alumina, titania, boehmite, sulfuric barium acid, calcium carbonate, phosphoric acid calcium, amorphous silica, mesoporous silica, fumed silica, crystalline glass particles, kaolin, talc, silica-alumina composite oxide particles, calcium fluoride, lithium fluoride, zeolite, molybdenum sulfide, mica, magnesium oxide, or combinations thereof.

The inorganic particles may be included in an amount of 0.001 parts by weight to 50 parts by weight, based on 100 parts by weight of the polymer resin.

The elastic sheet may further include an additive, and the additive may include an initiator, a cross-linking agent, a coupling agent, a stabilizer, an inert gas, or a combination thereof.

The embodiments may be realized by providing an elastic sheet for an all-solid rechargeable battery, the elastic sheet having a thickness of 100 μm, and a strain of 30% or less in a vacuum environment of 0.1 MPa.

The embodiments may be realized by providing an elastic sheet for an all-solid rechargeable battery, the elastic sheet having a thickness of 500 μm, and a strain of 5% or less in a vacuum environment of 0.1 MPa.

The embodiments may be realized by providing an all-solid rechargeable battery including a plurality of unit cells including a solid electrolyte layer stacked in one direction; and the elastic sheet according to an embodiment between the plurality of unit cells.

The all-solid rechargeable battery may further include a case accommodating the plurality of unit cells and the elastic sheet, the case maintaining the plurality of unit cells and the elastic sheet at a vacuum environment of 0.1 MPa.

### BRIEF DESCRIPTION OF THE DRAWINGS

Features will be apparent to those of skill in the art by describing in detail exemplary embodiments with reference to the attached drawings in which:

FIG. 1 is a cross-sectional view showing an all-solid rechargeable battery according to an embodiment.

FIG. 2 is a cross-sectional view showing an all-solid rechargeable battery according to another embodiment.

FIG. 3 is a table showing experimental results of alignment distortion of Experimental Example 2, Experimental Example 3, and Comparative Example 1.

FIG. 4 is a table showing experimental results of alignment distortion of Experimental Example 4 and Comparative Example 2.

FIG. 5 is a table showing experimental results of alignment distortion of an Experimental Example 5 and Comparative Example 3.

### DETAILED DESCRIPTION

The terminology used herein is used to describe embodiments only, and is not intended to limit the present disclosure. The singular expression includes the plural expression unless the context clearly dictates otherwise.

As used herein, “a combination thereof” refers to a mixture, a stack, a composite, a copolymer, an alloy, a blend, a reaction product, and the like of constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, numbers, steps, elements, or a combination thereof.

In the drawings, the thickness of layers, films, panels, regions, etc., may be exaggerated for clarity, and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. Also, unless otherwise defined, the average particle diameter may be taken by randomly measuring the size (a diameter or a length of a major axis) of about 20 particles in a scanning electron microscope image to obtain a particle size distribution and obtaining the diameter D50 of the particle with the cumulative volume of 50 volume % as the average particle diameter in the particle size distribution.

Here, “or” is not interpreted in an exclusive sense. For example, “A or B” is interpreted as including A, B, A+B, etc.

“Metal” is interpreted as a concept that includes general metals, transition metals, and semi-metals.

An all-Solid Rechargeable Battery

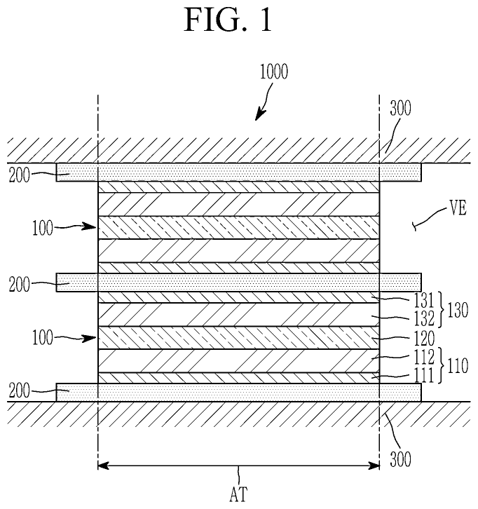

FIG. 1 is a cross-sectional view of an all-solid rechargeable battery according to an embodiment.

Referring to FIG. 1, an all-solid rechargeable battery 1000 according to an embodiment may include a structure in which a plurality of unit cells 100 including a negative electrode 110 (including an anode including a negative current collector 111 and a negative active material layer 112), a solid electrolyte layer 120, and a positive electrode 130 (including a cathode including a positive active material layer 132 and a positive current collector 131) is stacked in a direction (e.g., a vertical direction) and may be housed in a case 300 forming or providing a vacuum environment (VE). The all-solid rechargeable battery 1000 may further include an elasticity or elastic sheet 200 outside at least one of the positive electrode 130 and the negative electrode 110. In an implementation, the elastic sheet 200 may be outside the plurality of unit cells 100 and between the plurality of unit cells 100. In an implementation, as illustrated in FIG. 1, a stack may include two unit cells 100 including the negative electrode 110, the solid electrolyte layer 120, and the positive electrode 130, or the stack include three or more unit cells 100. In an implementation, the stack may include, e.g., 2 to 100 unit cells 100, 3 to 50 unit cells 100, and 4 to 20 unit cells 100.

The all-solid rechargeable battery 1000 may be manufactured by pressing the plurality of unit cells 100 in the manufacturing process, and may include a structure in which the charge and discharge proceed in the pressed state. In an implementation, the elastic sheet 200 may be expressed as a buffer layer or elastic layer, the contact of the solid components included in the plurality of unit cells 100 may be improved by ensuring that pressure is transmitted uniformly to the plurality of unit cells 100, it may also play a role in relieving the stress transmitted to the solid electrolyte layer, and play a role in suppressing the occurrence of cracks in the solid electrolyte layer due to the stress accumulation according to changes in the thickness of the electrode during the charge and discharge.

In an implementation, as shown in FIG. 1, the elastic sheet 200 may be between the plurality of unit cells 100 and may be on an outermost layer of the plurality of unit cells 100. The thickness of the negative electrode may change significantly during the charge and discharge, e.g., due to a lithium electrodeposition or dendrite formation, and the elastic sheet 200 may play a role in buffering or accommodating the changes in the thickness by being on the outside of the negative electrode 110, e.g., on the opposite side of the surface in contact with the solid electrolyte layer 120 in the negative electrode 110. In an implementation, the elastic sheet 200 may help prevent the degradation due to the reacting with lithium by being positioned outside the positive electrode 130 or the negative electrode 110, thereby obtaining an effect of increasing the Coulomb efficiency of the all-solid rechargeable battery.

The plurality of unit cells 100 stacked in one direction included in the all-solid rechargeable battery may be within an align tolerance AT, even if the elastic sheet 200 were to be deformed depending on the vacuum pressure. In an implementation, the align tolerance AT of the plurality of unit cells 100 may include a maximum range that the alignment distortion value of the plurality of unit cells 100 may be tolerated in the battery in a horizontal direction that intersects the vertical direction in which plurality of unit cells 100 are stacked.

In one embodiment, the elastic sheet for the all-solid rechargeable battery may have a thickness of 100 μm to 500 μm and a strain of 10% or less in a vacuum environment of 0.1 MPa. The elastic sheet that satisfies these properties may effectively relieve the stress caused by the changes in the thickness during the charging and discharging of the all-solid rechargeable battery, improve the Coulomb efficiency and lifespan characteristics, and suppress the alignment distortion of the all-solid unit cells stacked in one direction.

The thickness of the elastic sheet may be 100 μm to 500 μm, e.g., 300 μm, 100 μm, or 500 μm. In an implementation, the thickness of the elastic sheet may vary depending on the positions between the plurality of unit cells stacked in one direction.

The strain of the elastic sheet may be the strain of the width of the elastic sheet in the vacuum environment of 0.1 MPa.

The elastic sheet may have the strain of 10% or less in the vacuum environment of 0.1 MPa. Here, the strain may mean measuring the amount of the change in the width of the elastic sheet after positioning the elastic sheet from an atmospheric pressure of 45 degrees Celsius to the vacuum environment of 0.1 MPa. In an implementation, the strain of the elastic sheet may be a value calculated according to Equation 1 below.

$$A strain ( \% ) of an elastic sheet = \qquad [ Equation 1 ]$$

$$\{ \vert ( a width of an elastic sheet of an atmospheric pressure ) -$$

$$( a width of an elastic sheet of a vacuum environment of 0.1 MPa ) \vert /$$

$$( a width of an elastic sheet of an atmospheric pressure ) \} \times 100$$

In an implementation, in the vacuum environment of 0.1 MPa, the strain of the elastic sheet may be 10% or less when the elastic sheet thickness is 300 μm, 30% or less when the elastic sheet thickness is 100 μm, or 5% or less when the elastic sheet thickness is 500 μm.

Within the above ranges, the stress changes due to the charge and discharge may be effectively alleviated while providing the appropriate compressive strength to the all-solid rechargeable battery, thereby simultaneously suppressing the alignment distortion of the all-solid unit cells stacked in one direction which improves the Coulomb efficiency and lifespan characteristics of the all-solid rechargeable battery.

The elastic sheet may include a polymer resin. In an implementation, the type of the polymer resin may be a suitable polymer resin as long as the elastic sheet may satisfy the above-mentioned physical properties. In an implementation, it may include polyacrylate, polyurethane, silicon, a fluorine polymer, a polyether polyol, a polyester polyol, a polycarbonate polyol, a copolymer thereof, or a combination thereof.

The polyacrylate refers to a single polymer or a copolymer with an acryl group, and the polyurethane refers to a single polymer or a copolymer with a urethane group. The silicon may also be referred to as a silicon resin and refers to a single polymer or a copolymer including silicon, and the fluorine polymer refers to a single polymer or copolymer including fluorine. These polymers may exhibit appropriate elasticity, modularity, and compressive strain, thereby is suitable for use as the elastic sheet.

As the polymer resin, polyether polyol for polyurethane may be used. Polyether polyol may have a functional group count of 2 to 4 and a number average molecular weight of 2,000 to 4,000.

In addition to the polyether polyol, poly ester polyol may be used. As the polyester polyol, examples may include those obtained by condensation of low molecular polyols such as ethylene glycol, diethylene glycol, propylene glycol, butanediol, hexanediol, glycerine, trimethylolpropane, trimethylolethane, pentaerythritol, diglycerin, sorbitol, and sucrose with succinic acid, sebacic acid, maleic acid, fumaric acid, phthalic acid, isophthalic acid, succinic acid anhydride, maleic anhydride, or phthalic acid anhydride. In an implementation, the polyester polyol include polyols that are ring-opening condensations of caprolactone and methyl valerolactone, which are classified as lactone esters. Examples of polycarbonate polyols may include those obtained by de-alcohol reaction of polyhydric alcohols such as ethylene glycol, diethylene glycol, propylene glycol, butanediol, pentanediol, and hexanediol with di-alkyl carbonate, di-alkylene carbonate, and di-phenyl carbonate. In an implementation, the number of functional groups may be 2 to 3 and the number average molecular weight is 500 to 1,000 (or hydroxyl group is 112 mg KOH/g to 224 mg KOH/g).

In an implementation, the polyacrylate may be derived from C1 to C20 alkyl acrylate, hydroxy C1 to C20 alkyl acrylate, or a combination thereof.

Here, C1 to C20 refers to the number of carbons in the alkyl group, and may be, for example, C1 to C18, C1 to C15, C1 to C12, C1 to C10, C1 to C8, or C1 to C5. Here, acrylate is a concept that includes acrylate and methacrylate.

The C1 to C20 alkyl acrylate, e.g., may be methyl (meth)acrylate, ethyl (meth)acrylate, propyl (meth)acrylate, butyl (meth)acrylate, 2-ethylhexyl (meth)acrylate, 2-ethylpentyl (meth)acrylate, 2-ethylheptyl (meth)acrylate, 2-ethylnonyl (meth)acrylate, 2-propylhexyl (meth)acrylate, and 2-propyloctyl (meth)acrylate, or a combination thereof.

The hydroxy C1 to C20 alkyl acrylate, e.g., may be 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, or a combination thereof.

In an implementation, the acrylate resin may be derived from C1 to C20 alkyl acrylate and hydroxy C1 to C20 alkyl acrylate, and a mixing ratio of C1 to C20 alkyl acrylate and hydroxy C1 to C20 alkyl acrylate may be a weight ratio of 20:80 to 90:10, e.g., 30:70 to 90:10 or 40:60 to 90:10, and the weight ratio may be 50:50 to 90:10 or 60:40 to 80:20. In an implementation, the acrylate resin may exhibit appropriate adhesion and may be advantageous in realizing excellent compressive strength, stress relaxation rate, and recovery rate.

The acrylate resin may further include other repeating units of acrylic acid, alkoxy group-including acrylate, or the like. In an implementation, the weight average molecular weight of the acrylate resin may be 400,000 to 2,000,000.

The elastic sheet may include a foam. It may include a foam with porosity of the elastic sheet.

The elastic sheet may further include hollow particles in addition to a polymer resin.

The hollow particle is a particle with an empty interior and may be expressed as a hollow sphere or a hollow bead, and may be a hollow nanoparticle or a hollow microparticle. In an implementation, the elastic sheet may include the hollow particles, and the compressive strength may be increased while maintaining the appropriate density and a foam shape may be exhibited.

The hollow particle may be included as 1 part by weight to 8 parts by weight, based on 100 parts by weight of the polymer resin, e.g., 1 part by weight to 7 parts by weight, or 2 parts by weight to 6 parts by weight may be included. Including the hollow particles within these content ranges may help ensure that it is advantageous to create a foam-type elastic sheet, and the compressive strength, the stress relief, and the restoration ability of the elastic sheet may be improved.

The hollow particle may be an inorganic hollow particle, an organic hollow particle, or a combination thereof. In an implementation, the hollow particle may be made of an inorganic material or may be made of an organic material such as a polymer.

The inorganic hollow particles may include, e.g., glass, metal oxide, metal carbide, metal fluoride, or combinations thereof. In an implementation, the inorganic hollow particle may be made of glass, silicon oxide, nickel oxide, barium oxide, platinum oxide, zinc oxide, aluminum oxide, zirconium oxide, iron oxide, titanium oxide, calcium carbonate, magnesium fluoride, or a combination thereof, e.g., the inorganic hollow particle may be a glass bubble.

The organic hollow particles may include, e.g., acryl resin, vinyl chloride resin, urea resin, phenol resin, rubber, or combinations thereof. In an implementation, the organic hollow particle may be an expansion-type or a non-expansion-type, and the expansion-type organic hollow particle may be one that expands at, e.g., 120° C. to 150° C.

In an implementation, the size D50 of the hollow particle may be a micro size, e.g., 2 μm to 100 μm, 5 μm to 90 μm, 10 μm to 80 μm, or 20 μm to 70 μm. The hollow particles with these sizes may be advantageous for making the foam-shaped elastic sheets, and may help improve the compressive strength of the elastic sheet while lowering density and improving the stress relief and the resilience. Here, the size of the hollow particle may be expressed as an average particle diameter or a median particle diameter, and is measured with a particle size analyzer, and may mean the diameter D50 of the particles with a cumulative volume of 50 volume % in the particle size distribution.

The elastic sheet may further include elastic particles in addition to the polymer resin. The elastic particle may be a particle made of a polymer with elasticity, e.g., a rubber. The elastic particles may help increase resilience while maintaining the stress relieving power of the polymer resin.

The elastic particles may be included in an amount of 0.1 parts by weight to 5 parts by weight, based on 100 parts by weight of the polymer resin, e.g., 0.5 parts by weight to 4 parts by weight, or 1 part by weight to 3 parts by weight. Including the elastic particles with these content ranges may help ensure that the compressive strength, the stress relief, and the restoring force may be maximized without reducing the density and adhesion of the polymer resin.

The elastic particles may include, e.g., polymers derived from natural rubber, alkyl acrylate, olefin, butadiene, isoprene, styrene, acrylonitrile, copolymers thereof, or combinations thereof. The elastic particle may have a glass transition temperature of, e.g., −70° C. to 0° C.

The alkyl acrylate may be a C1 to C20 alkyl acrylate, e.g., methyl methacrylate, ethyl methacrylate, propyl methacrylate, butyl methacrylate, 2-ethylhexyl methacrylate, 2-ethyl pentyl (meth)acrylate, 2-ethylheptyl (meth)acrylate, 2-ethylnonyl (meth)acrylate, 2-propylhexyl (meth)acrylate, and 2-propyloctyl (meth)acrylate, or a combination thereof.

The elastic particle may include, e.g., poly alkyl acrylate, ethylene-propylene-diene rubber, butadiene rubber, isoprene rubber, styrene-butadiene rubber, styrene-isoprene rubber, acrylonitrile-butadiene rubber, or combinations thereof.

The elastic particle may have, e.g., a core-shell structure, and in this case, it may be advantageous to exhibit the appropriate size and elasticity. The core and shell may each include poly alkyl acrylate, e.g., the core may include poly butyl (meth)acrylate, and the shell may include polymethyl (meth)acrylate. In this case, dispersion within the elastic sheet composition may be excellent, and the compressive strength, stress relief, and resilience of the elastic sheet may be improved.

The elastic particle may be, e.g., a nano size. In an implementation, the size D50 of the elastic particle may be 10 nm to 900 nm, e.g., 10 nm to 700 nm, 50 nm to 500 nm, or 100 nm to 400 nm. The elastic particles that satisfy these sizes may have excellent dispersion within the elastic sheet composition and may help increase the resilience while maintaining the stress relieving ability of the elastic sheet. Here, the size of the elastic particle may be expressed as an average particle diameter or a median particle diameter, and be measured with a particle size analyzer, and may mean the diameter D50 of a particle with a cumulative volume of 50 volume % in the particle size distribution.

The elastic sheet may further include inorganic particles. In an implementation, the recovery rate may be simultaneously improved while improving the modulus and compressive strength of the elastic sheet.

The inorganic particles include, e.g., alumina, titania, boehmite, sulfuric acid barium, calcium carbonate, phosphoric acid calcium, amorphous silica, mesoporous silica, fumed silica, crystalline glass particle, kaolin, talc, silica-alumina composite oxide particle, calcium fluoride, lithium fluoride, zeolite, molybdenum sulfide, mica, magnesium oxide, or combinations thereof.

The inorganic particles may be included in an amount of, e.g., 0.001 parts by weight to 50 parts by weight, 0.01 parts by weight to 45 parts by weight, or 0.1 parts by weight to 40 parts by weight, based on 100 parts by weight of the polymer resin. In this case, the compressive strength, stress relaxation rate, and recovery rate of the elastic sheet may be improved without deteriorating the characteristics of the polymer resin.

The average particle diameter of the inorganic particle may be 0.1 μm to 2 μm, e.g., 0.1 μm to 1.5 μm, or 0.2 μm to 1.0 μm. The average particle diameter is measured using a laser scattering particle size distribution meter, and may mean a median particle diameter D50 when 50% is accumulated from the particle side in a volume conversion.

The elastic sheet may further include suitable additives in addition to the components described above, e.g., an initiator, a cross-linking agent, a coupling agent, a foaming agent, a stabilizer, or the like. In an implementation, in order to manufacture the foam-type elastic sheet, the elastic sheet may include an inert gas such as nitrogen or argon in addition to or together with the foaming agent.

Each additive may be included in a suitable amount according to the purpose, e.g., 0.001 parts by weight to 20 parts by weight, based on 100 parts by weight of the polymer resin, 0.01 parts by weight to 10 parts by weight, 0.1 parts by weight to 5 parts by weight, or 1 part by weight to 3 parts by weight.

### A Solid Electrolyte Layer

In the all-solid rechargeable battery according to an embodiment, the solid electrolyte layer 120 may include inorganic solid electrolytes such as sulfide solid electrolytes or oxide solid electrolytes.

In an implementation, the solid electrolyte layer 120 may include a sulfide solid electrolyte with excellent ion conductivity. The sulfide solid electrolyte particle, e.g., may include Li₂S—P₂S₅, Li₂S—P₂S₅—LiX (X is a halogen element, for example, I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m, n are an integer, respectively, Z is Ge, Zn, or Ga), Li₂S—GeS₂, Li₂S—SiS₂—Li₃PO₄, Li₂S—SiS₂—LiₚMO_{q} (p, q are an integer, respectively, M is P, Si, Ge, B, Al, Ga, or In), or combinations thereof.

The sulfide solid electrolyte may be obtained, e.g., by mixing Li₂S and P₂S₅ at a mole ratio of 50:50 to 90:10, or 50:50 to 80:20 and performing selective heat treatment. Within these mixing ratio ranges, the sulfide solid electrolytes with excellent ion conductivity may be produced. In an implementation, as another component, by further including SiS₂, GeS₂, B₂S₃, the ion conductivity may be further improved.

A mechanical milling or a solution method may be applied as a mixing method of sulfur-including raw materials to produce the sulfide solid electrolyte. The mechanical milling is a method of making starting materials into particulates and mixing the same by putting the starting materials, ball mills, or the like in a reactor and intensely stirring them. In the solution method, starting materials may be mixed in a solvent to obtain a solid electrolyte as a precipitate. In an implementation, heat treatment may be performed after mixing, and crystals of the solid electrolyte can become more rigid and ionic conductivity can be improved. In an implementation, the sulfide solid electrolyte can be manufactured by mixing sulfur-containing raw materials and heat-treating them two or more times. In this case, a sulfide solid electrolyte with high ionic conductivity and rigidity may be manufactured.

In an implementation, the sulfide solid electrolyte may be manufactured, e.g., through a first heat treatment for mixing the sulfur-containing raw material and firing it at 120° C. to 350° C. and a second heat treatment for mixing a first heat treatment result product and firing it at 350° C. to 800° C. The first heat treatment and the second heat treatment may be performed under an inert gas or nitrogen atmosphere, respectively. The first heat treatment may be performed for 1 hour to 10 hours, and the second heat treatment may be performed for 5 hours to 20 hours. Through the first heat treatment, an effect of milling small raw materials may be obtained, and through the second heat treatment, the final solid electrolyte may be synthesized. Through two or more heat treatments like this, a high-performance sulfide solid electrolyte with high ion conductivity and robustness may be obtained, and such a solid electrolyte may be said to be suitable for mass production. The temperature of the first heat treatment may be, e.g., 150° C. to 330° C., or 200° C. to 300° C., and the temperature of the second heat treatment may be, e.g., 380° C. to 700° C., or 400° C. to 600° C.

In an implementation, the sulfide solid electrolyte particles may include an argyrodite-type sulfide. The argyrodite-type sulfide can be represented by, e.g., Chemical Formula of LiₐM_{b}P_{c}S_{d}Aₑ (a, b, c, d, and e are all 0 or greater and 12 or less, M is Ge, Sn, Si, or a combination thereof, and A is F, Cl, Br, or I). In an implementation, it can be represented by a Chemical Formula of Li₇₋ₓPS₆₋ₓAₓ (x is 0.2 or greater and 1.8 or less, and A is F, Cl, Br, or I). In an implementation, the argyrodite-type sulfide may be, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or the like.

A sulfide solid electrolyte particle containing such argyrodite-type sulfide may have high ionic conductivity close to about 10⁻⁴ to about 10⁻² S/cm, which is ionic conductivity of a general liquid electrolyte, at room temperature, and thus can form a close bond between the positive active material and the solid electrolyte, and further, a close interface between the electrode layer and the solid electrolyte layer without deteriorating the ionic conductivity. An all-solid battery including the same may exhibit improved battery performance such as rate characteristics, Coulombic efficiency, and life characteristics.

The argyrodite-type sulfide solid electrolyte can be manufactured by, e.g., mixing lithium sulfide, phosphorus sulfide, and optionally lithium halide. After mixing them, heat treatment may be performed. The heat treatment may include, e.g., two or more heat treatment steps. Here, manufacturing the argyrodite-type sulfide solid electrolyte, for example, may include a first heat treatment for mixing a raw material and firing it at 120° C. to 350° C., and a second heat treatment for mixing the first heat treatment result again and firing it at 350° C. to 800° C.

In an implementation, the solid electrolyte layer 120 may further include an oxide inorganic solid electrolyte. The oxide inorganic solid electrolyte may include, e.g., Li₁₊ₓTi₂₋ₓAl (PO₄)₃ (LTAP) (0≤x≤4), Li_{1+x+y}AlₓTi₂₋ₓSi_{y}P_{3-y}O₁₂ (0≤x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB (Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} PO₄₃, 0<x<2, 0<y<3), Li_{1+x+y}(Al, Ga)ₓ(Ti, Ge)₂₋ₓSi_{y}P_{3-y}O₁₂ (0<x<1, 0<y<1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, or garnet ceramics Li₃₊ₓLa₃M₂O₁₂ (M=Te, Nb, or Zr; x is an integer from 1 to 10), or combinations thereof.

The solid electrolyte may be in a particle form, and the average particle diameter D50 of the particle may be 5.0 μm or less, e.g., 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. The solid electrolyte may be elementary particles of 0.1 μm to 1.9 μm, large particles of 2.0 μm to 5.0 μm, or a mixture thereof. The average particle diameter of the sulfide solid electrolyte particle may be measured using a microscope image. For example, a particle size distribution may be obtained by measuring sizes of about 20 particles in a scanning electron microscope image, and D50 may be calculated from the particle size distribution.

In an implementation, the average particle diameter D50 of the solid electrolyte included in the solid electrolyte layer 120 may be larger than the average particle diameter D50 of the solid electrolyte included in the positive electrode 130. In this case, the overall performance may be improved by maximizing the energy density of the all-solid rechargeable battery and increasing the mobility of lithium ions. In an implementation, the average particle diameter D50 of the solid electrolyte included in the positive electrode 130 may be 0.1 μm to 1.9 μm, or 0.1 μm to 1.0 μm, and the average particle diameter D50 of the solid electrolyte included in the solid electrolyte layer 120 may be 2.0 μm to 5.0 μm, 2.0 μm to 4.0 μm, or 2.5 μm to 3.5 μm. Within the above particle diameter ranges, the energy density of the all-solid secondary battery may be maximized and the transfer of lithium ions is facilitated, making it possible to suppress resistance and thus to improve the overall performance of the all-solid secondary battery.

The solid electrolyte layer may further include a binder, in addition to the solid electrolyte. The binder may include, e.g., a nitrile-butadiene rubber, a hydrogenated nitrile-butadiene rubber, styrene-butadiene rubber, acrylated styrene-butadiene rubber, acrylonitrile-butadiene rubber, acryl rubber, butyl rubber, fluorine rubber, polydimethylsiloxane, polyethylene oxide, polyvinylpyrrolidone, polyvinylpyridine, chlorosulfonated polyethylene, polyvinyl alcohol, polytetrafluoroethylene, polyvinylidene fluoride, polyvinylidene fluoride-hexafluoropropylene copolymer, polyvinylchloride, carboxylated polyvinylchloride, polyvinylfluoride, polyethylene, polypropylene, ethylene propylene copolymer, ethylene propylene diene copolymer, polyamideimide, polyimide, poly(meth)acrylate, polyacrylonitrile, polystyrene, polyurethane, or combinations thereof.

The solid electrolyte layer 120 may be formed by adding a solid electrolyte to a binder solution, coating a base film with the solution, and drying the resultant. The solvent for the binder solution may be isobutyl isobutyrate, xylene, toluene, benzene, hexane, or a combination thereof.

In an implementation, the solid electrolyte layer 120 may further include an alkali metal salt, an ionic liquid, or a conductive polymer.

The alkali metal salt may be, e.g., a lithium salt. A concentration of the lithium salt in the solid electrolyte layer may be 1 M or more, e.g., 1 M to 4 M. In this case, the lithium salt may help improve ionic conductivity by improving lithium ion mobility in the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB C₂O₄₂, LiBF₄, LiBF₃ C₂F₅, lithium bis(oxalato) borate (LiBOB), lithium oxalyl difluoro borate (LIODFB), lithium difluoro(oxalato) borate (LiDFOB), lithium bis(trifluoro methanesulfonyl)imide, LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In an implementation, the lithium salt may be an imide salt. In an implementation, the imide lithium salt may include lithium bis(trifluoro methanesulfonyl)imide, LiTFSI, LiN(SO₂CF₃)₂), lithium bis(fluorosulfonyl)imide, LiFSI, or LiN(SO₂F)₂). The lithium salt may maintain or improve ionic conductivity by appropriately maintaining chemical reactivity with an ionic liquid.

The ionic liquid refers to a salt or a room temperature molten salt that has a melting point equal to or lower than a room temperature, is in a liquid state at room temperature and is composed of only ions.

The ionic liquid may be a compound including a cation, e.g., ammonium, pyrrolidinium, pyridinium, pyrimidinium, imidazolium, piperidinium, pyrazolium, oxazolium, pyridazinium, phosphonium, sulfonium, triazolium cations, or a mixture thereof, and an anion, e.g., BF₄−, PF₆−, AsF₆−, SbF₆−, AlCl₄−, HSO₄−, ClO₄−, CH₃SO₃−, CF₃CO₂−, Cl−, Br−, I−, BF₄−, SO₄−, CF₃SO₃−, FSO₂₂N−, (C₂F₅SO₂)₂N−, (C₂F₅SO₂, CF₃SO₂)N−, or (CF₃SO₂)₂N−.

The ionic liquid may be, e.g., N-methyl-N-propyl pyrrolidinium bis(trifluoromethane sulfonyl)imide, N-butyl-N-methylpyrrolidium bis(3-trifluoromethylsulfonyl)imide, 1-butyl-3-methylimidazolium bis(trifluoromethylsulfonyl)amide, or 1-ethyl-3-methylimidazolium bis(trifluoromethyl sulfonyl)amide.

A weight ratio of the solid electrolyte and the ionic liquid in the solid electrolyte layer may be 0.1:99.9 to 90:10, e.g., 10:90 to 90:10, 20:80 to 90:10, 30:70 to 90:10, 40:60 to 90:10, or 50:50 to 90:10. The solid electrolyte layer that satisfies the above ranges may help maintain or improve ionic conductivity by improving the electrochemical contact area with the electrode. Accordingly, the energy density, discharge capacity, rate characteristics, and the like of the all-solid battery can be improved.

### A Negative Electrode

The negative electrode for an all-solid battery may include, e.g., a current collector and a negative active material layer on the current collector.

The negative active material layer may include a negative active material and may further include a binder or a conductive material.

The negative active material may include a material capable of reversibly intercalation/deintercalation of lithium ions, lithium metal, an alloy of lithium metal, a material capable of being doped and dedoped with lithium, or a transition metal oxide.

The material capable of reversibly intercalating/deintercalating lithium ions may be a carbon negative active material, and may include, e.g., crystalline carbon, amorphous carbon, or a combination thereof. Examples of the crystalline carbon may include graphite such as amorphous, plate-like, flake-like, spherical, or fibrous natural graphite or artificial graphite, and examples of the amorphous carbon may include soft carbon or hard carbon, mesophase pitch carbide, fired coke, and the like.

For the alloy of the lithium metal, an alloy of lithium and metal, e.g., Na, K, Rb, Cs, Fr, Be, Mg, Ca, Sr, Si, Sb, Pb, In, Zn, Ba, Ra, Ge, Al, or Sn, may be used.

For the material capable of being doped or undoped on the lithium, a silicon negative active material or a Sn negative active material may be used. Examples of the Si negative active material may include silicon, silicon-carbon composite, SiOₓ (0<x<2), and a Si-Q alloy (Q is an alkali metal, alkali earth metal, Group 13 element, Group 14 element, Group 15 element, Group 16 element, transition metal, rare-earth element, or combinations thereof, but is not Si). Examples of the Sn negative active material may include Sn, SnO₂, a Sn_R alloy (R is an alkali metal, alkali earth metal, Group 13 element, Group 14 element, Group 15 element, Group 16 element, transition metal, rare-earth element, or combinations thereof, but is not Sn). In an implementation, a mixture of at least one thereof and SiO₂ may be used. The elements Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

In an implementation, the negative active material may include silicon-carbon composite particles. The average particle diameter D50 of the silicon-carbon composite particle may be, e.g., 0.5 μm to 20 μm. The average particle diameter D50 is measured with a particle size analyzer and refers to the diameter of a particle with a cumulative volume of 50 volume % in the particle size distribution. With respect to 100 wt % of the silicon-carbon composite particle, silicon may be included from 10 wt % to 60 wt % and carbon may be included from 40 wt % to 90 wt %. The silicon-carbon composite particle may include, e.g., a core including a silicon particle, and a carbon coating layer on the surface of the core. The average particle diameter D50 of the silicon particle in the core may be 10 nm to 1 μm, or 10 nm to 200 nm. The silicon particle may exist as silicon alone, in a form of a silicon alloy, or in an oxidized form. The oxidized form of silicon may be expressed as SiOₓ (0<x<2). In an implementation, the thickness of the carbon coating layer may be about 5 nm to 100 nm.

In an implementation, the silicon-carbon composite particle may include a core including silicon particles and crystalline carbon, and a carbon coating layer on the surface of the core and containing amorphous carbon. In an implementation, in the silicon-carbon composite particle, amorphous carbon may not exist in the core but only in the carbon coating layer. The crystalline carbon may be artificial graphite, natural graphite, or a combination thereof, and the amorphous carbon may be formed from coal pitch, mesophase pitch, petroleum pitch, coal oil, petroleum heavy oil, or polymer resin (phenol resin, furan resin, polyimide resin, or the like). In an implementation, with respect to 100 wt % of the silicon-carbon composite particle, the content of the crystalline carbon may be 10 wt % to 70 wt %, and the content of the amorphous carbon may be 20 wt % to 40 wt %.

In the silicon-carbon composite particle, the core may include voids in the central portion. The radius of the void may be 30 length % to 50 length % of the radius of the silicon-carbon composite particle.

The aforementioned silicon-carbon composite particles may help effectively suppress volume expansion, structural collapse, or particle crushing due to the charge and discharge, and therefore, a conductive path disconnection may be prevented, high-capacity and high efficiency may be realized, and the use in high voltage or high-speed charge conditions is advantageous.

The Si negative active material or Sn negative active material may be used by mixing with a carbon negative active material. A mixing ratio of the Si negative active material or Sn negative active material and the carbon negative active material may be 1:99 to 90:10 by weight.

The content of the negative active material in the negative active material layer may be 95 wt % to 99 wt %, based on the total weight of the negative active material layer.

In an implementation, the negative active material layer may further include a binder, and optionally, may further include a conductive material. A content of the binder in the negative active material layer may be 1 wt % to 5 wt %, based on the total weight of the negative active material layer. In an implementation, a conductive material may be further included, and the negative active material layer may include 90 wt % to 98 wt % of the negative active material, 1 wt % to 5 wt % of the binder, and 1 wt % to 5 wt % of the conductive material.

The binder may serve to adhere the negative active material particles to each other and also to adhere the negative active material to the current collector. The binder may include a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

Examples of the water-soluble binder may include a rubber binder or a polymer resin binder. The rubber binder may include a styrene-butadiene rubber, an acrylated styrene-butadiene rubber, an acrylonitrile-butadiene rubber, an acrylic rubber, a butyl rubber, a fluoro rubber, and a combination thereof. The polymer resin binder may be polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

In an implementation, a water-soluble binder may be used as the negative electrode binder, and a thickener capable of imparting viscosity may be used together therewith. In an implementation, the thickener may include, e.g., a cellulose compound. The cellulose compound may include carboxymethyl cellulose, hydroxypropylmethyl cellulose, methyl cellulose, alkali metal salts thereof, or a combination thereof. As the alkali metal, Na, K, or Li may be used. An amount of the thickener used may be 0.1 to 3 parts by weight, based on 100 parts by weight of the negative active material.

The conductive material may be used to provide conductivity to an electrode, and for the battery being constructed, a suitable electron conductive material may be used as long as it does not cause chemical changes, e.g., a carbon material such as natural graphite, artificial graphite, carbon black, acetylene black, Ketjen black, a carbon fiber, or a carbon nanotube; a metal material in the form of metal powder or metal fiber including copper, nickel, aluminum, silver, or the like; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

In an implementation, the negative electrode for an all-solid battery may be a precipitation-type negative electrode. The precipitation-type negative electrode refers to a negative electrode which does not include a negative active material during assembling of a battery but in which lithium metal or the like is precipitated during charging of the battery and serves as a negative active material.

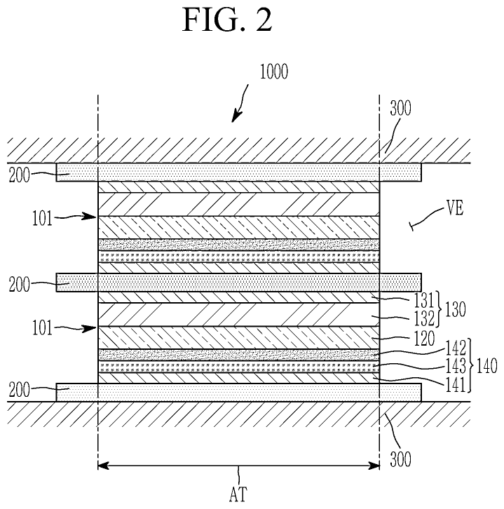

FIG. 2 is a cross-sectional view of an all-solid battery including a precipitation-type negative according to another embodiment.

Referring to FIG. 2, the precipitation-type negative electrode 140 of the plurality of unit cells 101 stacked in one direction may include a negative current collector 141 and a negative coating layer 142 on the current collector. In an all-solid battery having the precipitation-type negative electrode 140, initial charging may begin in the absence of a negative active material, and during the charging, lithium metal with a high density or the like may be precipitated between the negative current collector 141 and the negative coating layer 142 and forms a lithium metal layer 143, which may serve as a negative active material. Accordingly, in an all-solid battery that has been charged once or more, the precipitation-type negative electrode 140 may include the negative current collector 141, the lithium metal layer 143 on the negative current collector 141, and the negative coating layer 142 on the lithium metal layer 143. The lithium metal layer 143 refers to a layer of lithium metal or the like precipitated during the charging process of the battery and may be called a metal layer or a negative active material layer.

The negative coating layer 142 may be referred to as a lithium electrodeposition induction layer, or a negative catalyst layer, and may include metal, carbon material, or a combination thereof that acts as a catalyst.

The metal may be a lithium-friendly metal, e.g., a metal alloyable with lithium, and may include, e.g., gold, platinum, palladium, silicon, silver, aluminum, bismuth, tin, zinc, or a combination thereof, and may include one or several of these. It may be composed of several types of alloys. In an implementation, the metal may be present in the form of a particle, and an average particle diameter (D50) thereof may be about 4 μm or less, e.g., 10 nm to 4 μm.

The carbon material may be, e.g., crystalline carbon, amorphous carbon, or a combination thereof. The crystalline carbon may be, e.g., natural graphite, artificial graphite, a mesophase carbon microbead, or a combination thereof. The amorphous carbon may be, e.g., carbon black, activated carbon, acetylene black, Denka black, Ketjen black, or a combination thereof.

In an implementation, the negative coating layer 142 may include both the metal and the carbon material, and a mixing ratio of the metal and the carbon material may be, e.g., 1:10 to 2:1 by weight. In this case, the precipitation of lithium metal can be effectively promoted and the characteristics of the all-solid rechargeable battery can be improved. The negative coating layer 142 may include, e.g., a carbon material on which catalyst metal is supported, or a mixture of metal particles and carbon material particles.

The negative coating layer 142 may include, e.g., a lithium-friendly metal and amorphous carbon, and in this case, it may effectively promote precipitation of lithium metal. In an implementation, the negative coating layer 142 may include a composite material in which a lithium-friendly metal is supported on amorphous carbon.

The negative coating layer 142 may further include a binder, and the binder may be a conductive binder. In an implementation, the negative coating layer 142 may further include a suitable additive, e.g., a filler, a dispersant, or an ion conductive material.

The thickness of the negative coating layer 142 may be, e.g., 100 nm to 20 μm, or 500 nm to 10 μm, or 1 μm to 5 μm.

The precipitation-type negative electrode 140 may further include a thin film on the surface of the current collector, e.g., between the current collector and the negative electrode coating layer.

The thin film may include an element that can form an alloy with lithium. The element that can form an alloy with lithium may be, e.g., gold, silver, zinc, tin, indium, silicon, aluminum, bismuth, or the like, which may be used alone or as an alloy of more than one thereof. The thin film can further help planarize a precipitation shape of the lithium metal layer 143 and further improve the characteristics of the all-solid-state battery. The thin film may be formed by, e.g., a vacuum deposition method, a sputtering method, a plating method, or the like. The thin film may have a thickness ranging from, e.g., 1 nm to 500 nm.

The lithium metal layer 143 may include lithium metal or lithium alloy. The lithium alloy, e.g., may include a Li—Al alloy, a Li—Sn alloy, a Li—In alloy, a Li—Ag alloy, a Li—Au alloy, a Li—Zn alloy, a Li—Ge alloy, a Li—Si alloy, or the like.

The thickness of the lithium metal layer 143 may be 1 μm to 500 μm, 1 μm to 200 μm, 1 μm to 100 μm, or 1 μm to 50 μm. If the thickness of the lithium metal layer 143 were to be too thin, it could be difficult to perform the role of lithium storage, and if it were to be too thick, the performance could be deteriorated as a battery volume increases.

In an implementation, the precipitation-type negative electrode may be applied, and the negative coating layer 142 may play a role in protecting the lithium metal layer 143 and suppressing the precipitation growth of a lithium dendrite. Accordingly, a short circuit and capacity deterioration of the all-solid battery may be suppressed and the lifespan characteristic may be improved.

### A Positive Electrode

An embodiment may include a positive current collector and a positive active material layer on the current collector. In an implementation, the positive active material layer may include a positive active material and a solid electrolyte and may selectively include a binder or conductive material.

### A Positive Active Material

The positive active material may be a suitable material for all-solid-state secondary batteries. In an implementation, the positive active material may be a compound capable of reversible intercalation and deintercalation of lithium and may include a compound represented by any of the following chemical formulas.

LiₐA_{1-b}X_{b}D′₂(0.90≤a≤1.8,0≤b≤0.5);

LiₐA_{1-b}X_{b}O_{2-c}D′_{c}(0.90≤a≤1.8,0≤b≤0.5,0≤c≤0.05);

LiₐE_{1-b}X_{b}O_{2-c}D′_{c}(0.90≤a≤1.8,0≤b≤0.5,0≤c≤0.05);

LiₐE_{2-b}X_{b}O_{4-c}D′_{c}(0.90≤a≤1.8,0≤b≤0.5,0≤c≤0.05);

LiₐNi_{1-b-c}Co_{b}X_{c}D′_{α}(0.90≤a≤1.8,0≤b≤0.5,0≤c≤0.5,0≤α≤2);

LiₐNi_{1-b-c}Co_{b}X_{c}O_{2-α}T_{α}(0.90≤a≤1.8,0≤b≤0.5,0≤c≤0.05,0≤α≤2);

LiₐNi_{1-b-c}Co_{b}X_{c}O_{2-α}T₂(0.90≤a≤1.8,0≤b≤0.5,0≤c≤0.05,0≤α≤2);

LiₐNi_{1-b-c}Mn_{b}X_{c}D′_{α}(0.90≤a≤1.8,0≤b≤0.5,0≤c≤0.05,0≤α≤2);

LiₐNi_{1-b-c}Mn_{b}X_{c}O_{2-α}T_{α}(0.90≤a≤1.8,0≤b≤0.5,0≤c≤0.05,0≤α≤2);

LiₐNi_{1-b-c}Mn_{b}X_{c}O_{2-α}T₂(0.90≤a≤1.8,0≤b≤0.5,0≤c≤0.05,0≤α≤2);

LiₐNi_{b}E_{c}G_{d}O₂(0.90≤a≤1.8,0≤b≤0.9,0≤c≤0.5,0.001≤d≤0.1);

LiₐNi_{b}Co_{c}Mn_{d}GₑO₂(0.90≤a≤1.8,0≤b≤0.9,0≤c≤0.5,0≤d≤0.5,0.001≤e≤0.1);

LiₐNiG_{b}O₂(0.90≤a≤1.8,0.001≤b≤0.1);

LiₐCoG_{b}O₂(0.90≤a≤1.8,0.001≤b≤0.1);

LiₐMn_{1-b}G_{b}O₂(0.90≤a≤1.8,0.001≤b≤0.1);

LiₐMn₂G_{b}O₄(0.90≤a≤1.8,0.001≤b≤0.1);

LiₐMn_{1-g}G_{g}PO₄(0.90≤a≤1.8,0≤g≤0.5);

QO₂;QS₂;LiQS₂;

V₂O₅;LiV₂O₅;

LiZO₂;

LiNiVO₄;

Li_{(3-f)}J₂(PO₄)₃(0≤f≤2);

Li_{(3-f)}Fe₂(PO₄)₃(0≤f≤2);

LiₐFePO₄(0.90≤a≤1.8).

In the above formulas, A may be Ni, Co, Mn, or a combination thereof, X may be Al, Ni, Co, Mn, Cr, Fe, Mg, Sr, V, rare earth elements, or a combination thereof; D′ may be O, F, S, P, or a combination thereof; E may be Co, Mn, or a combination thereof; T may be F, S, P, or a combination thereof, G may be Al, Cr, Mn, Fe, Mg, La, Ce, Sr, V, or a combination thereof; Q may be Ti, Mo, Mn, or a combination thereof; Z may be Cr, V, Fe, Sc, Y, or a combination thereof, and J may be V, Cr, Mn, Co, Ni, Cu, or a combination thereof.

The positive electrode active material may be, e.g., lithium cobalt oxide (LCO), lithium nickel oxide (LNO), lithium nickel cobalt oxide (NC), lithium nickel cobalt aluminum oxide (NCA), lithium nickel cobalt manganese oxide (NCM), and lithium nickel manganese oxide (NM), lithium manganese oxide (LMO), or lithium ferrous phosphate oxide (LFP).

The positive active material, e.g., may include a lithium nickel oxide represented by Chemical Formula 11, a lithium cobalt oxide represented by Chemical Formula 12, a lithium phosphoric acid iron compound represented by Chemical Formula 13, a cobalt-free lithium nickel-manganese oxide represented by Chemical Formula 14, or a combination thereof.

Liₐ₁Nₓ₁M¹_{y1}M²_{z1}O_{2-b1}X_{b1} [Chemical Formula 11]

In Chemical Formula 11, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² may each independently be Al, B, Ba, Ca, Ce, Co, Cr, Cu, Fe, Mg, Mn, Mo, Nb, Si, Sn, Sr, Ti, V, W, or Zr, and X may be F, P, or S.

In Chemical Formula 11, 0.6≤x1≤1, 0≤y1≤0.4, 0≤z1≤0.4, or 0.8≤x11, 0≤y1≤0.2, 0≤z1≤0.2.

Liₐ₂Coₓ₂M³_{y2}O_{2-b2}X_{b2} [Chemical Formula 12]

In Chemical Formula 12, 0.9≤a2≤1.8, 0.7≤x2≤1, 0≤y2≤0.3, 0.9≤x2+y2≤1.1, 0≤b2≤0.1, M³ may be Al, B, Ba, Ca, Ce, Cr, Cu, Fe, Mg, Mn, Mo, Ni, Se, Si, Sn, Sr, Ti, V, W, Y, Zn, or Zr, and X may be F, P, or S.

Liₐ₃Feₓ₃M⁴_{y3}PO_{4-b3}X_{b3} [Chemical Formula 13]

In Chemical Formula 13, 0.9≤a3≤1.8, 0.6≤x3≤1, 0≤y3≤0.4, 0≤b3≤0.1, M⁴ may be Al, B, Ba, Ca, Ce, Co, Cr, Cu, Mg, Mn, Mo, Ni, Se, Si, Sn, Sr, Ti, V, W, Y, Zn, or Zr, and X may be F, P, or S.

Liₐ₄Niₓ₄Mn_{y4}M⁵_{z4}O_{2-b4}X_{b4} [Chemical Formula 14]

In Chemical Formula 14, 0.9≤a2≤1.8, 0.8≤x4≤1, 0≤y4≤0.2, 0≤z4≤0.2, 0.9≤x4+y4+z4≤1.1, 0≤b4≤0.1, M⁵ may be Al, B, Ba, Ca, Ce, Cr, Fe, Mg, Mo, Nb, Si, Sn, Sr, Ti, V, W, or Zr, and X may be F, P, or S.

An average particle diameter (D50) of the positive electrode active material may be 1 μm to 25 μm, e.g., 3 μm to 25 μm, 1 μm to 20 μm, 1 μm to 18 μm, 3 μm to 15 μm, or 5 μm to 15 μm. In an implementation, the positive active material may include elementary particles with the average particle diameter D50 of 1 μm to 9 μm and large particles with the average particle diameter D50 of 10 μm to 25 μm. The positive electrode active material having the particle diameter range can be harmoniously mixed with other components in the first positive electrode active material layer and can implement the high capacity and high energy density. Here, the average particle diameter may be by selecting about 20 particles randomly from a scanning electron microscope image of the positive active material, measuring the particle diameter (a diameter, a long diameter or length of a major axis) and then obtaining a particle size distribution, and taking the diameter D50 of particles with a cumulative volume of 50 volume % is taken as the average particle diameter in the particle size distribution.

The positive electrode active material may be in the form of a secondary particle made by agglomeration of a plurality of primary particles, or may be in the form of a single particle. In an implementation, the positive electrode active material may be spherical or close to a spherical shape, or may be polyhedral or amorphous.

In an implementation, the positive active material may include a buffer layer on the particle surface. The buffer layer may be expressed as a coating layer, a protective layer, or the like, and may play a role in lowering the interface resistance of the positive active material and the sulfide solid electrolyte particle. In an implementation, the buffer layer may include lithium-metal-oxide, and the metal may include, e.g., Al, B, Ca, Ce, Cr, Fe, Mg, Mo, Nb, Si, Sn, Sr, Ta, V, W, or Zr. The lithium-metal-oxide may be excellent for improving the performance of the positive active materials by facilitating a movement of lithium ions and electron conduction, while lowering the interface resistance between the positive active material and the solid electrolyte particle.

The positive active material may be included at 55 wt % to 99 wt %, e.g., 65 wt % to 95 wt %, or 75 wt % to 91 wt %, based on a total weight of the positive active material layer.

### A Solid Electrolyte

The solid electrolyte included in the positive active material layer may include a sulfide solid electrolyte, an oxide solid electrolyte, or a combination thereof, e.g., an argyrodite-type sulfide solid electrolyte. The solid electrolyte may be the same as described above.

Based on a total weight of the positive active material layer, the solid electrolyte may be included in an amount of 0.1 wt % to 35 wt %, e.g., 1 wt % to 35 wt %, 5 wt % to 30 wt %, 8 wt % to 25 wt %, or 10 wt % to 20 wt %.

In an implementation, in the positive active material layer, based on the total weight of the positive active material and the solid electrolyte, the positive active material may be included at 65 wt % to 99 wt % and the solid electrolyte may be included at 1 wt % to 35 wt %, e.g., the positive active material may be included at 80 wt % to 90 wt % and the solid electrolyte may be included at 10 wt % to 20 wt %. Within these amounts, the efficiency and lifespan characteristics of the all-solid battery may be improved without deteriorating the capacity.

### Binder

The binder may serve to well adhere the positive electrode active material particles to each other and to well adhere the positive electrode active material to the current collector. In an implementation, the binder may be polyvinyl alcohol, carboxymethylcellulose, hydroxypropyl cellulose, diacetyl cellulose, polyvinyl chloride, carboxylated polyvinyl chloride, polyvinyl fluoride, polymer including ethylene oxide, polyvinylpyrrolidone, polyurethane, polytetrafluoroethylene, polyvinylidene fluoride, polyethylene, polypropylene, styrene-butadiene rubber, acryl federated styrene-butadiene rubber, epoxy resin, or nylon.

The content of the binder in the positive active material layer may be approximately 0.1 wt % to 5 wt %, based on a total weight of the positive active material layer.

### A Conductive Material

The positive active material layer may further include a conductive material. The conductive material may be included to provide electrode conductivity. A suitable electrically conductive material may be used as a conductive material unless it causes a chemical change. Examples of the conductive material may include a carbon material such as natural graphite, artificial graphite, carbon black, acetylene black, ketjen black, carbon fiber, carbon nanotubes, and the like; a metal material having a shape of a metal powder or a metal fiber including copper, nickel, aluminum, silver, or the like; a conductive polymer such as a polyphenylene derivative; or a mixture thereof.

The content of the conductive material in the positive active material layer may be 0 wt % to 3 wt %, 0.01 wt % to 2 wt %, or 0.1 wt % to 1 wt %, based on a total weight of the positive active material layer.

In an implementation, aluminum foil may be used as the positive current collector.

The all-solid rechargeable battery may be a unit battery with a structure of the positive electrode/solid electrolyte layer/negative electrode, a bicell with a structure of the negative electrode/solid electrolyte layer/anode/solid electrolyte layer/negative electrode, or a stacked battery in which these structures are repeated.

In an implementation, the shape of the all-solid-state battery may be, e.g., a coin shape, a button shape, a sheet shape, a stack shape, a cylindrical shape, a flat shape, or the like. In an implementation, the all-solid-state battery can also be applied to large-sized batteries used in electric vehicles, or the like. In an implementation, the all-solid-state battery can also be used in a hybrid vehicle such as a plug-in hybrid electric vehicle (PHEV). In an implementation, it can be used in fields that require a large amount of power storage, and can also be used with an electric bicycle, an electric tool, or the like. In an implementation, the all-solid rechargeable battery can be used in various fields such as portable electronic devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Experimental Example 1

### 1. Manufacturing of an Elastic Sheet

4-hydroxybutyl acrylate (4-HBA, Osaka Organic Chemical), 2-ethylhexyl acrylate (2-EHA, LG Chemical), and isobornyl acrylate (IBOA, Osaka Organic Chemical) were mixed in a weight ratio of 25:65:10, 0.01 parts by weight of a photoinitiator (Irgacure 651) was added thereto and a dissolved oxygen was exchanged into nitrogen gas in the reactor, and then ultraviolet rays were irradiated for several minutes using a lamp with a UV intensity of 10 mw/cm² to partially polymerize a monomer, thereby preparing an acrylate polymer resin.

As an elastic particle, being manufactured using an emulsion polymerization method, as a core-shell particle composed of 70 wt % of poly butyl acrylate core and 30 wt % of polymethylmethacrylate shell, an organic nano particle with an average particle diameter of 200 nm was prepared.

100 parts by weight of the prepared acrylate polymer resin, 2 parts by weight of the elastic particles, and 0.01 parts by weight of the initiator (Irgacure 651) were mixed in the reactor. In a viscous liquid, an initiator (Irgacure 651) (0.3 parts by weight), hexanediol diacrylate as a cross-linking agent (0.1 parts by weight), hollow particles (glass bubbles; 3M™ K1, median particle diameter 65 μm) (4 parts by weight), and fumed silica (AEROSIL 200) 0.1 (parts by weight) were mixed to prepare an adhesive elastic sheet composition.

The elastic sheet composition was applied between polyethylene terephthalate (PET) films as a releasing film, and irradiated with a light dose of 2,000 mJ/cm² using ultraviolet rays to produce an elastic sheet adhered on the PET film. The thickness of the elastic sheet (Sheet A) manufactured according to experimental Example 1 was 300 μm, and the strain was 2%, which is less than 10%, in a vacuum environment of 0.1 MPa.

### 2. Manufacturing of a Positive Electrode

LiNi_{0.8}Co_{0.15}Mn_{0.05}O₂ positive active material (85 wt %) coated with Li₂O—ZrO₂, lithium argyrodite-type solid electrolyte Li₆PS₅Cl (13.5 wt %), polyvinylidene fluoride binder (1.0 wt %), and a carbon nanotube conductive material (0.5 wt %) were mixed to manufacture a positive composition. The prepared positive composition was coated on a positive current collector by using a bar coater, dried, and rolled to produce a positive electrode.

### 3. Manufacturing of a Solid Electrolyte Layer

A slurry was prepared by adding an argyrodite-type solid electrolyte Li₆PS₅Cl (D50=3 μm) to a binder solution in which acryl binder (SX-A334, Zeon) was dissolved in isobutyl isobutyrate (IBIB) solvent and stirring. The slurry included 98.5 wt % of a solid electrolyte and 1.5 wt % of a binder. The slurry was applied on a release PET film with a bar coater and dried at ambient temperature to produce a solid electrolyte layer.

### 4. Manufacturing of a Negative Electrode

An Ag/C composite was prepared by mixing carbon black (having a primary particle diameter D50 of about 30 nm) and silver (Ag) (having an average particle diameter D50 of about 60 nm) at a weight ratio of 3:1, and a negative coating layer composition was prepared by adding and mixing 0.25 g of the composite to 2 g of an NMP solution including 7 wt % of polyvinylidene fluoride binder. This was coated on a nickel foil current collector by using a bar coater and vacuum-dried to prepare a precipitation-type of negative electrode with a negative coating layer on the current collector.

5. Manufacturing of an all-Solid Battery

A plurality of unit cells stacked in one direction were manufactured by stacking them in the order of the negative electrode/solid electrolyte/positive electrode/solid electrolyte/negative electrode. The unit cells were placed inside a case including an aluminum case stack film, etc., a vacuum environment of 0.1 MPa was formed or provided inside the case, and then pressed to produce an all-solid rechargeable battery unit cell. The aluminum case was unpacked and stacked in the following order of the elastic sheet/negative electrode/solid electrolyte/positive electrode/solid electrolyte/negative electrode/elastic sheet/negative electrode/solid electrolyte/positive electrode/solid electrolyte/negative electrode/elastic sheet. Next, a 0.1 MPa vacuum environment was formed inside the aluminum stack film, and the stacked cells were stored to manufacture an all-solid rechargeable battery.

The thickness of the elastic sheet (Sheet A) according to Experimental Example 1 was 300 μm, and in the vacuum environment of 0.1 MPa inside the case, the strain of the elastic sheet was 2%, which is less than 10%.

### Experimental Example 2

The elastic sheet and all-solid rechargeable battery according to Experimental Example 2 were manufactured using substantially the same method as Experimental Example 1, except that Experimental Example 2 manufactured the elastic sheet by increasing the porosity of the elastic sheet compared to Experimental Example 1. The thickness of the elastic sheet (Sheet B) according to Experimental Example 2 was 300 μm, and in the vacuum environment of 0.1 MPa inside the case, the strain of the elastic sheet was 3%, which is less than 10%.

### Experimental Example 3

The elastic sheet and all-solid rechargeable battery according to Experimental Example 3 were manufactured using substantially the same method as Experimental Example 1, except that Experimental Example 3 manufactured the elastic sheet by increasing the porosity of the elastic sheet compared to Experimental Example 1. The thickness of the elastic sheet (Sheet C) according to Experimental Example 3 was 300 μm, and in the vacuum environment of 0.1 MPa inside the case, the strain of the elastic sheet was 10%.

### Comparative Example 1

An elastic sheet and an all-solid rechargeable battery according to Comparative Example 1 were manufactured using substantially the same method as Experimental Example 1, except that Comparative Example 1 manufactured the elastic sheet by increasing the porosity of the elastic sheet compared to Experimental Example 1. The thickness of the elastic sheet according to Comparative Example 1 was 300 μm, and in the vacuum environment of 0.1 MPa inside the case, the strain of the elastic sheet was 16%, which is more than 10%.

### Experiment Result 1

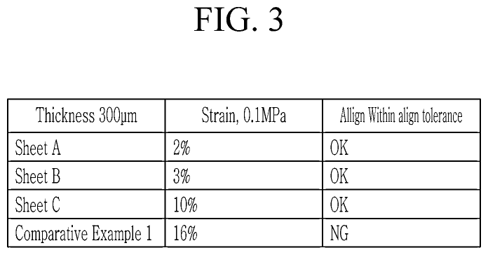

FIG. 3 is a table showing experimental results of alignment distortion of Experimental Example 1, Experimental Example 2, Experimental Example 3, and Comparative Example 1.

Referring to FIG. 3, in each all-solid rechargeable battery according to Experimental Example 1 (Sheet A), Experimental Example 2 (Sheet B), and Experimental Example 3 (Sheet C), it may be seen that the plurality of unit cells stacked in one direction were positioned within the alignment tolerance in a vacuum environment of 0.1 MPa.

The all-solid rechargeable battery according to Experimental Example 1 (Sheet A), Experimental Example 2 (Sheet B), and Experimental Example 3 (Sheet C) satisfied the numerical constraints of the elastic sheet thickness of 300 μm and the strain of the elastic sheet of 10% or less in a vacuum environment of 0.1 MPa, and accordingly in the vacuum environment of 0.1 MPa, the plurality of unit cells stacked in one direction were positioned within the align tolerance.

In contrast, in the all-solid rechargeable battery according to Comparative Example 1, the thickness of the elastic sheet was 300 μm, and the strain of the elastic sheet was 16%, which is more than 10%, in a vacuum environment of 0.1 MPa, and the plurality of unit cells stacked in one direction caused the alignment distortion and exceeded the alignment tolerance in the vacuum environment of 0.1 MPa due to the deformation of the elastic sheet therebetween.

According to Experimental Result 1, by alleviating the stress transmitted to the all-solid unit cell and the stress generated in the all-solid unit cell when charging and discharging were repeated, to implement the task and effect of suppressing the alignment distortion of the all-solid unit cells stacked in one direction while suppressing the damage to all-solid unit cells and improving the charge and discharge efficiency and lifespan characteristics of the all-solid rechargeable batteries, it may be seen that the numerical limit configuration in which the thickness of the elastic sheet is 300 μm and the strain of the elastic sheet is less than 10% in the vacuum environment of 0.1 MPa, referring to FIG. 3, may have a threshold significance that may confirm that the upper limit is the threshold value through Experimental Example 1 (Sheet A), Experimental Example 2 (Sheet B), Experimental Example 3 (Sheet C), and Comparative Example 1.

For example, if the strain of the elastic sheet were to be less than 1% in a vacuum environment of 0.1 MPa, the stress relief effect on the plurality of unit cells could be deteriorated due to the deformation of the elastic sheet.

### Experimental Example 4

The elastic sheet and all-solid rechargeable battery according to Experimental Example 4 were manufactured using substantially the same method as Experimental Example 1, except that Experimental Example 4 manufactured the elastic sheet by increasing the porosity of the elastic sheet compared to Experimental Example 1. The thickness of the elastic sheet (Sheet D) according to Experimental Example 4 was 100 μm, and in a vacuum environment of 0.1 MPa inside the case, the strain of the elastic sheet was 30%, e.g., 30% or less.

### Comparative Example 2

An elastic sheet and an all-solid rechargeable battery according to Comparative Example 2 were manufactured using substantially the same method as Experimental Example 1, except that Comparative Example 2 manufactured the elastic sheet by increasing the porosity of the elastic sheet compared to Experimental Example 1. The thickness of the elastic sheet according to Comparative Example 2 was 100 μm, and in a vacuum environment of 0.1 MPa inside the case, the strain of the elastic sheet was 5000, which is more than 30%.

### Experimental Result 2

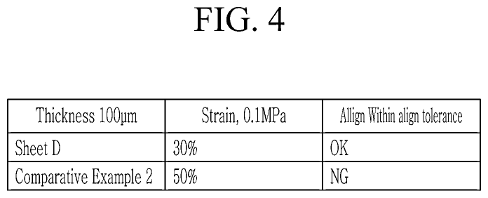

FIG. 4 is a table showing experimental results of alignment distortion of Experimental Example 4 and Comparative Example 2.

Referring to FIG. 4, in the-solid rechargeable battery according to Experimental Example 4 (Sheet D), it may be seen that the plurality of unit cells stacked in one direction were positioned within the alignment tolerance in a vacuum environment of 0.1 MPa.

The all-solid rechargeable battery according to Experimental Example 4 (Sheet D) had the elastic sheet thickness of 100 μm and satisfied the numerical limit of the strain of the elastic sheet being 30% or less in a 0.1 MPa vacuum environment, so the plurality of unit cells stacked in one direction in the 0.1 MPa vacuum environment were positioned within the alignment tolerance.

In contrast, in the all-solid rechargeable battery according to Comparative Example 2, the thickness of the elastic sheet was 100 μm, the strain of the elastic sheet was 50%, which is more than 30% in a vacuum environment of 0.1 MPa, and the plurality of unit cells stacked in one direction in a vacuum environment of 0.1 MPa were out of the alignment tolerance due to the alignment distortion occurring due to the deformation of the elastic sheet placed between them.

According to Experimental Result 2, by alleviating the stress transmitted to the all-solid unit cell and the stress generated in the all-solid unit cell when charging and discharging are repeated, to implement the task and effect of suppressing the alignment distortion of the all-solid unit cells stacked in one direction while suppressing the damage to all-solid unit cells and improving the charge and discharge efficiency and lifespan characteristics of the all-solid rechargeable batteries, it may be seen that the numerical limit configuration in which the thickness of the elastic sheet was 300 μm and the strain of the elastic sheet was less than 30% in the vacuum environment of 0.1 MPa, referring to FIG. 3, had a threshold significance that may confirm that the upper limit is the threshold value through Experimental Example 4 (Sheet D) and Comparative Example 2.

### Experimental Example 5

An elastic sheet and an all-solid rechargeable battery according to an Experimental Example 5 were manufactured using substantially the same method as Experimental Example 1, except that Experimental Example 5 manufactured the elastic sheet by increasing the porosity of the elastic sheet compared to Experimental Example 1. The thickness of the elastic sheet (Sheet E) according to Experimental Example 5 was 500 μm, and in a vacuum environment of 0.1 MPa inside the case, the strain of the elastic sheet was 5%, which is 5% or less.

### Comparative Example 3

An elastic sheet and an all-solid rechargeable battery according to Comparative Example 3 were manufactured using substantially the same method as Experimental Example 1, except that Comparative Example 3 manufactured the elastic sheet by increasing the porosity of the elastic sheet compared to Experimental Example 1. The thickness of the elastic sheet according to Comparative Example 3 was 500 μm, and in a vacuum environment of 0.1 MPa inside the case, the strain of the elastic sheet was 10%, which is more than 5%.

### Experimental Result 3

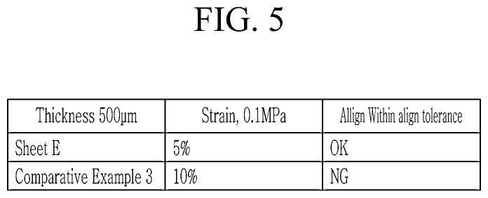

FIG. 5 is a table showing experimental results of alignment distortion of Experimental Example 5 and Comparative Example 3.

Referring to FIG. 5, in the all-solid rechargeable batteries according to Experimental Example 5 (Sheet E), it may be seen that the plurality of unit cells stacked in one direction were positioned within the alignment tolerance in a vacuum environment of 0.1 MPa.

The all-solid rechargeable battery according to Experimental Example 5 (Sheet E) satisfied the numerical limit that the elastic sheet thickness was 500 μm and the strain of the elastic sheet was 5% or less in a 0.1 MPa vacuum environment, so the plurality of unit cells stacked in one direction were positioned within the align tolerance in a vacuum environment of 0.1 MPa.

In contrast, the all-solid rechargeable battery according to the Comparative Example 3 had the elastic sheet thickness of 500 μm, and the strain of the elastic sheet was 10%, which is more than 5% in a vacuum environment of 0.1 MPa, the plurality of unit cells stacked in one direction in a vacuum environment of 0.1 MPa were out of the alignment tolerance due to the alignment distortion occurring due to the deformation of the elastic sheet placed between them.

According to Experimental Result 3, by alleviating the stress transmitted to the all-solid unit cell and the stress generated in the all-solid unit cell while charging and discharging were repeated, to implement the task and effect of suppressing the alignment distortion of the all-solid unit cells stacked in one direction while suppressing the damage to all-solid unit cells and improving the charge and discharge efficiency and lifespan characteristics of the all-solid rechargeable batteries, it may be seen the numerical limit configuration that the thickness of the elastic sheet was 500 μm and the strain of the elastic sheet was less than 5% in the vacuum environment of 0.1 MPa, referring to FIG. 5, had a threshold significance that may confirm that the upper limit is the threshold value through Experimental Example 5 (Sheet A) and Comparative Example 3.

According to the above-mentioned Experimental Result 1, Experimental Result 2, and Experimental Result 3, by alleviating the stress transmitted to the all-solid unit cell and the stress generated in the all-solid unit cell while charging and discharging are repeated, to implement the task and effect of suppressing the alignment distortion of the all-solid unit cells stacked in one direction while suppressing the damage to all-solid unit cells and improving the charge and discharge efficiency and lifespan characteristics of the all-solid rechargeable batteries, it may be seen that the numerically limited configuration in which the thickness of the elastic sheet is 100 μm to 500 μm and that the strain of the elastic sheet is less than 10% in a vacuum environment of 0.1 MPa had a threshold significance that may confirm that the upper limit is the threshold value through Experimental Example 1 (Sheet A), Experimental Example 2 (Sheet B), Experimental Example 3 (Sheet C), Experimental Example 4 (Sheet D), Experimental Example 5 (Sheet E), Comparative Example 1, Comparative Example 2, and Comparative Example 3.

By way of summation and review, some lithium rechargeable batteries may use an electrolyte solution including a flammable organic solvent, and there may be a safety issue of an explosion or fire in an event of a collision or penetration. Accordingly, semisolid batteries or all-solid batteries that avoid the use of the electrolyte solutions have been considered. The all-solid battery refers to a battery in which all materials are made up of solids, e.g., a battery that uses solid electrolytes. These all-solid batteries may be relatively safe as there may be little to no risk of the explosion due to electrolyte solution leakage, and may easily be used to manufacture thin batteries.

One or more embodiments may provide an elastic sheet for an all-solid batteries and an all-solid rechargeable battery that help suppress damage to the all-solid unit cell and improve charge and discharge efficiency and lifespan characteristics of the all-solid rechargeable battery, e.g., by relieving a stress transmitted to the all-solid unit cell and a stress generated in the all-solid unit cell during repeated charging and discharging.

The all-solid unit cell stacked during battery manufacturing may be exposed to a vacuum environment, and even if the elastic sheet were to be deformed, it is possible to provide an elastic sheet for an all-solid battery and an all-solid rechargeable battery that helps suppress alignment distortion of the all-solid unit cells stacked in one direction.

According to an embodiment, by alleviating the stress transmitted to the all-solid unit cell and the stress generated in the all-solid unit cell during repeated charging and discharging, the elastic sheet for the all-solid battery and all-solid rechargeable battery suppressing the damage to all-solid unit cells and improving the charge and discharge efficiency and lifespan characteristics of the all-solid rechargeable batteries may be provided.

In addition, even if the elastic sheet between the all-solid unit cells stacked in one direction were to be exposed to a vacuum environment during the battery manufacturing, it may be deformed below a certain level, so the alignment distortion of the all-solid unit cells may be suppressed.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An elastic sheet for an all-solid rechargeable battery, the elastic sheet having:
a thickness of 100 μm to 500 μm, and
a strain of 10% or less in a vacuum environment of 0.1 MPa.

2. The elastic sheet as claimed in claim 1, wherein the thickness of the elastic sheet is 300 μm.

3. The elastic sheet as claimed in claim 1, wherein the strain comprises a strain of a width of the elastic sheet.

4. The elastic sheet as claimed in claim 1, wherein the elastic sheet comprises a foam.

5. The elastic sheet as claimed in claim 1, wherein:
the elastic sheet comprises a polymer resin, and
the polymer resin comprises a polyacrylate, a polyurethane, silicon, a fluorine polymer, a polyether polyol, a polyester polyol, a polycarbonate polyol, a copolymer thereof, or combinations thereof.

6. The elastic sheet as claimed in claim 5, wherein the polyacrylate comprises a C1 to C20 alkyl acrylate, a hydroxy-substituted C1 to C20 alkyl acrylate, or a combination thereof.

7. The elastic sheet as claimed in claim 5, wherein the elastic sheet further comprises hollow particles.

8. The elastic sheet as claimed in claim 7, wherein the hollow particles are included in an amount of 1 part by weight to 8 parts by weight, based on 100 parts by weight of the polymer resin.

9. The elastic sheet as claimed in claim 7, wherein:
the hollow particles comprise inorganic hollow particles, organic hollow particles, or a combination thereof,
the inorganic hollow particles comprise glass, a metal oxide, a metal carbide, a metal fluoride, or a combination thereof, and
the organic hollow particles comprise an acryl resin, a vinyl chloride resin, a urea resin, a phenol resin, or a combination thereof.

10. The elastic sheet as claimed in claim 7, wherein an average particle diameter D50 of the hollow particles is 2 μm to 100 μm.

11. The elastic sheet as claimed in claim 5, wherein:
the elastic sheet further comprises elastic particles, and
the elastic particles comprise alkyl acrylate, an olefin, butadiene, isoprene, styrene, acrylonitrile, a copolymer thereof, or combinations thereof.

12. The elastic sheet as claimed in claim 11, wherein the elastic particle is included in an amount of 0.1 parts by weight to 5 parts by weight, based on 100 parts by weight of the polymer resin.

13. The elastic sheet as claimed in claim 11, wherein an average particle diameter D50 of the elastic particles is 10 nm to 900 nm.

14. The elastic sheet as claimed in claim 5, wherein:
the elastic sheet further comprises inorganic particles, and
the inorganic particles comprise alumina, titania, boehmite, sulfuric barium acid, calcium carbonate, phosphoric acid calcium, amorphous silica, mesoporous silica, fumed silica, crystalline glass particles, kaolin, talc, silica-alumina composite oxide particles, calcium fluoride, lithium fluoride, zeolite, molybdenum sulfide, mica, magnesium oxide, or combinations thereof.

15. The elastic sheet as claimed in claim 14, wherein the inorganic particles are included in an amount of 0.001 parts by weight to 50 parts by weight, based on 100 parts by weight of the polymer resin.

16. The elastic sheet as claimed in claim 5, wherein:
the elastic sheet further comprises an additive, and
the additive comprises an initiator, a cross-linking agent, a coupling agent, a stabilizer, an inert gas, or a combination thereof.

17. An elastic sheet for an all-solid rechargeable battery, the elastic sheet having:
a thickness of 100 μm, and
a strain of 30% or less in a vacuum environment of 0.1 MPa.

18. An elastic sheet for an all-solid rechargeable battery, the elastic sheet having:
a thickness of 500 μm, and
a strain of 5% or less in a vacuum environment of 0.1 MPa.

19. An all-solid rechargeable battery, comprising:
a plurality of unit cells comprising a solid electrolyte layer stacked in one direction; and
the elastic sheet as claimed in claim 1 between the plurality of unit cells.

20. The all-solid rechargeable battery as claimed in claim 19, further comprising a case accommodating the plurality of unit cells and the elastic sheet, the case maintaining the plurality of unit cells and the elastic sheet at a vacuum environment of 0.1 MPa.
